(19) United States
(12) Patent Application Publication
(10) Pub. No.: US 2015/0223410 A1
(43) Pub. Date: Aug. 13, 2015

(54) Vacuum Chambered Greenhouse Paneling System

(71) Applicants: Lauren Freeman Jensen, Orem, UT (US); La Donna Rae Jensen, Mappleton, UT (US)

(72) Inventors: Lauren Freeman Jensen, Orem, UT (US); La Donna Rae Jensen, Mappleton, UT (US)

(21) Appl. No.: 14/176,121

(22) Filed: Feb. 9, 2014

(51) Int. Cl. A01G 9/14

(52) U.S. Cl. CPC A01G 9/1469

(57) ABSTRACT

A greenhouse paneling system that has a very high R value that can be used in colder climates. Such panels being vacuum sealed and interconnected and maintained by an active pump. Such pump being electronically controlled based upon the temperature of the outside environment and to compensate for leakage.

### CROSS-REFERENCE TO RELATED APPLICATIONS

This application claims the benefit of provisional patent application Ser. No. 61/850,664, filed 2013 Feb. 21 by the present inventors.

### BACKGROUND

### Prior Art

The following is a tabulation of some prior art that presently appears relevant:

U.S. Patent Application Publications

| Application Number | Kind Code | Pub. Dt | Applicant |
|---|---|---|---|
| US20110183119 | A1 | Jul. 28, 2011 | Thomas Rotter |
| US20090233038 | A1 | Sep. 17, 2009 | Eldon Coppersmith |
| US20080245011 | A1 | Oct. 9, 2008 | Wolfgang Friedl |
| US20120315411 | A1 | Dec. 13, 2012 | Jerry Castelle |

Both professional food producers and home gardeners have used greenhouses for many years to get an early start on the growing season. Though these greenhouses may provide a couple of extra months, in colder climates they are not efficient at allowing food production year round.

It is a well known fact that convective heat transfer can be reduced by creating a vacuum, and this idea has been applied in the past. Patent application US201101839119 is such an example. One of the disadvantages of this design is that it requires at least four stratified sheets of material in any of its embodiments. The more sheets of material that the light has to go through increases the amount of light energy lost, and also increases the cost of the product. It has been commonly held that elaborate geometries, such as the prism structure in this invention, would be needed to keep the structure from collapsing, however, such elaborate shapes are not needed.

Patent application US20090233038 is another example of using a vacuum to create an insulater against heat in a parietal member. It also employs elaborate shapes to produce the strength needed to resist a vacuum. In the case here, they are circular in shape to hold the stresses from the vacuum. A tubular shape would not be ideal for a greenhouse because it would reflect light rays; also, towards the tube's end there wouldn't be much insulation.

Patent application US20080245011 is an example of using a vacuum to reduce heat transfer in a window which is very similar to the embodiments that will be discussed in this application. Metal strips are attached to the two sheets of glass and are folded out and welded together, it does not use bonded or welded plastics. Also the gap for the vacuum is relatively thin in this design.

A double pane window does reduce heat transfer but it is limited and does not necessarily have a high vacuum in the space between the two sheets of material. It usually employs air or a gas. Over time, air may penetrate the pane and cannot be generally maintained, nor would the material handle the high stress of a strong vacuum. The spacing in double pane windows is generally small because heat transfer becomes a significant problem when the space is too large. When the space becomes too great, the combination of a hot side and a cold side will lead to air moving, creating convective heat transfer.

Patent application US20120315411 is an example of employing a vacuum as an insulator in the walls of any building, not necessarily a greenhouse. In his patent, Jerry Castelle has various panels inside the walls of a conventional home. There is no mechanism for the loss of vacuum in the panels over time, nor are they transparent.

### BACKGROUND OF THE INVENTION

The present invention includes or comprises greenhouses, particularly greenhouses that can operate year round, even in colder climates, reducing the energy required for such.

Conventional greenhouse systems keep plants at a suitable temperature for growing by trapping energy from the sun by radiative heat transfer. They prevent energy from leaving the greenhouse through convective and conductive heat transfer by the use of transparent or translucent panels. This allows the operator of the greenhouse to get an early start on crops when it would normally have been too cold. However, conventional greenhouses have a hard time protecting plants from the cold in harsh climates, especially at night when no energy is entering the greenhouse via radiative heat transfer.

### SUMMARY OF THE INVENTION

The present invention is an improved greenhouse paneling system capable of operating in colder climates by maintaining heat with a higher efficiency over ordinary greenhouses. It will provide the house with a high insulation value wall.

### BRIEF DESCRIPTION OF THE DRAWINGS

FIG. 1 shows a possible variation of a single vacuum panel which uses a honeycomb structural support matrix.

FIG. 2 is an exploded view of the panel shown in FIG. 1.

FIG. 3 is an exploded view of an alternative vacuum panel which uses a simple rod matrix for structural support.

FIG. 4 shows two panels which are interconnected via vacuum hoses. A pump is shown which will create, maintain, and change the vacuum pressure inside the panels.

### DETAILED DESCRIPTION OF THE INVENTION

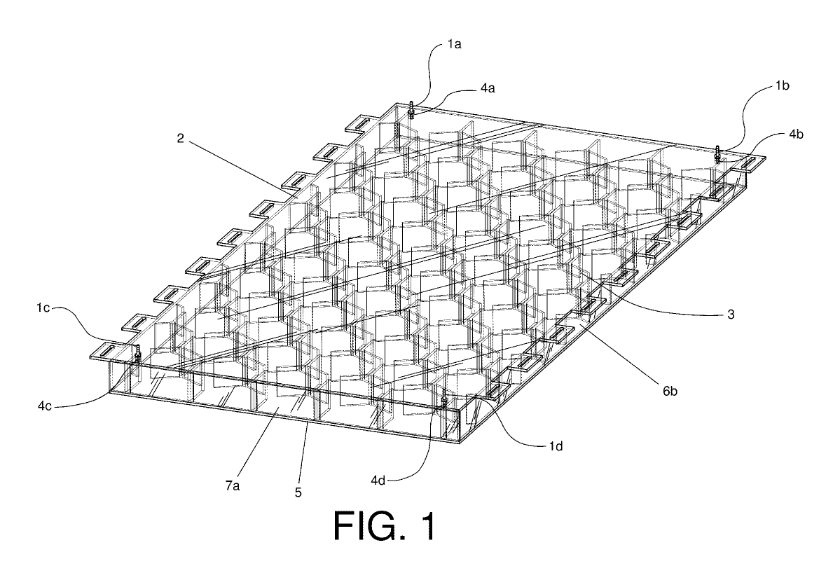

The greenhouse panels act as if they are insulated. Heat transfer is reduced by creating a vacuum between two sheets of a transparent material as shown in FIG. 1. Any material that allows a certain spectrum of light to penetrate it permitting a plant to grow, such as glass, acrylic, polycarbonate, etc, can be used.

The panels of the greenhouse will have a vacuum in the void; the actual air will be pumped out to form a vacuum in that space. It is not air gaps that will be used to increase the insulation value, but the presence of a vacuum.

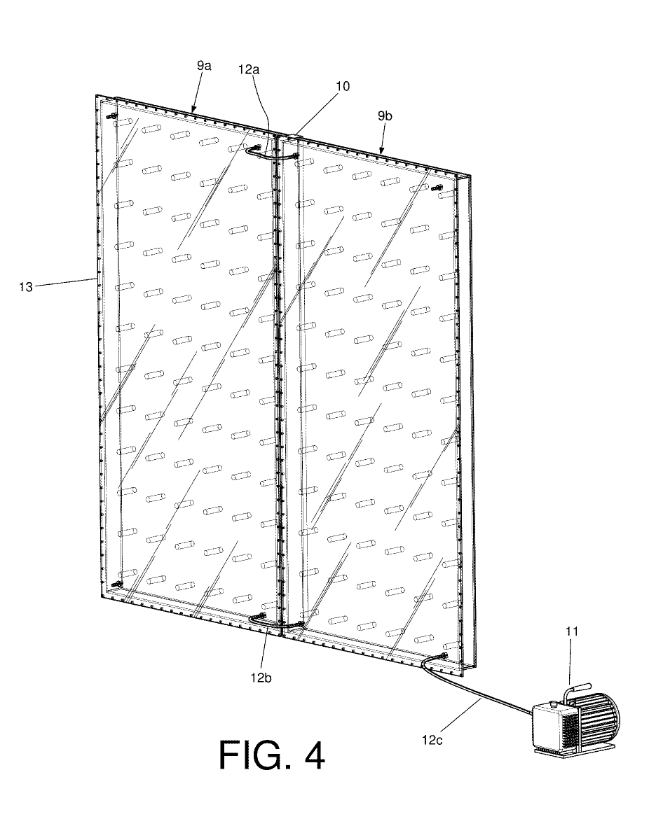

The panels can be linked to one another to form a system of interconnected panels. FIG. 4 shows two panels (9a, 9b) connected to one another using a hosing system (12a-12c). The panels have nozzles attached (1a-1d) as shown in FIGS. 1-3 by which hoses can be used to connect various panels together. The hoses can connect panels in any configuration. For illustration purposes FIG. 4 shows two panels (9a, 9b) side by side, attached to a structural member (10) between them. The panels are connected to one another by the hoses. Excess nozzles that are not needed in the construction of a greenhouse or greenroom can be plugged to prevent loss of vacuum.

A vacuum pump (11), electronically controlled, will actively maintain the vacuum in the chambers due to leakage or sublimation of the solid. The pump will be activated whenever the panels begin to lose vacuum pressure. It will pump more air out of the chambers, eliminating the problem of the panels loosing vacuum pressure over time. This continual removal of the gases overcomes the problem of the vapor pressure of the solids used in construction and the associated outgassing of those components, as well as the problem of leakage.

The another pump or valve can be actively controlled by a circuit that allows air back into the panels when the outside environment reaches high temperatures. This reduces the vacuum, causing an opposite effect of insulation, accelerating the heat transfer between the outside and inside of the greenhouse, keeping the greenhouse's temperature from becoming too hot. In the hotter summer months, this will prevent the plants from being overheated.

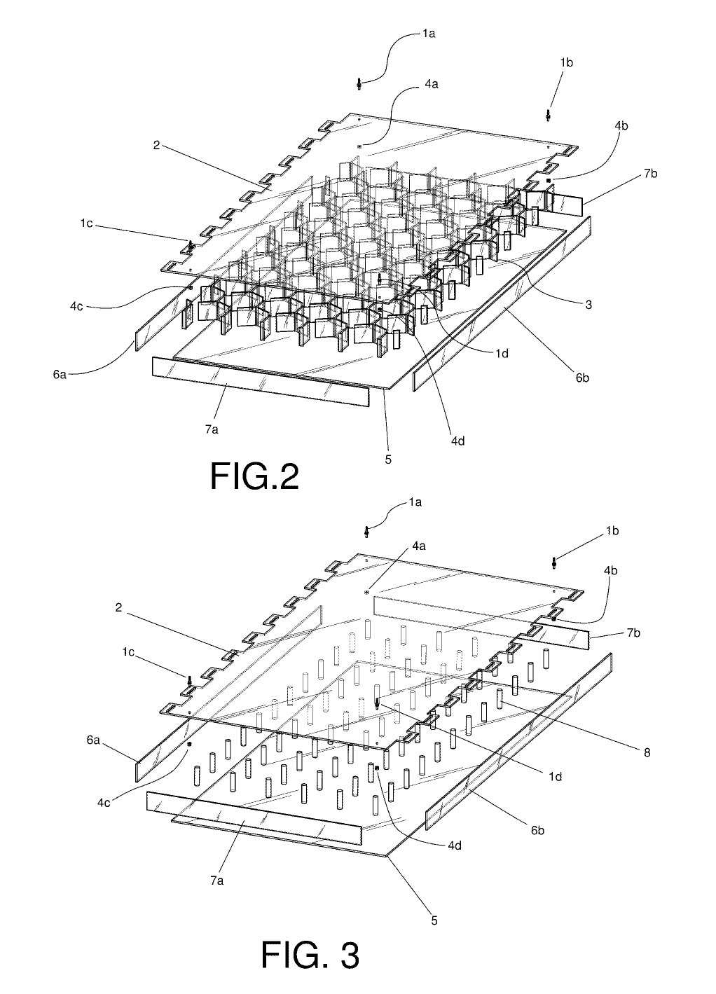

The exploded view of FIG. 2 shows one of the possible constructions of the panel. Using flat clear plastic sheet (5) as the base, sides (6a, 6b, 7a, 7b) can be attached air-tight to the edges of the base. One method of attaching polycarbonate sheets together is to use adhesives or, less obvious, they could be plastic welded. Another clear plastic sheet (2) can be placed on top and attached to the sides.

Between the base and top sheets support, support structures will be added to prevent collapsing, breaking, or cracking due to the force caused by the vacuum inside. The support structures allow the panels to be made larger in size, preventing collapse. FIG. 3 shows the most basic form of the support structures, simple rods (8) placed in a matrix. However, other types of structures can be employed to provide more strength. FIG. 2 shows a honey-comb shaped support matrix (3) which could also improve the strength and reduce the convection of the air by creating smaller pockets. The honeycomb matrix could be made up of three-sided supports at 120 degree angles from each other as shown in FIGS. 1 and 2.

One of the panels can be manufactured to have edges that overhang the rest of the panel. These edges can have slots, holes, or other means to allow fasteners to be used to attach the the panel to the framing of the greenhouse or greenroom. There are many ways to fasten the panels. In FIG. 1, the panel edges on part 2 are in the form of tabs with gaps in them. When installed, these tabs alternate with the adjacent panel; in other, words the gap of one panel allows for the tab of the neighboring panel. Another possible variation, as shown in FIG. 4, shows the edges (13) can be straight with holes in them for attachment. In this case the edges would be about half the length of the support member (10) between them and to which they are attached.

All of the panels will have nozzles (1a-1d) as shown on FIGS. 1-3 installed on them to allow hoses to be attached. The nozzles can be attached in many ways. One way, shown in FIGS. 2 and 3, is to place a nut (4a-4d), as shown on FIGS. 1-3, on the inside of the panel, screwed onto the nozzle. The nozzle itself having a flat rim attached to the outside. In addition to or instead of a nut, an adhesive could be used to attach the nozzles.

The panels shown in the drawings are rectangular, but they can be in any shape needed for the installation. For pitched roofs, they can be triangular, and for the sides of the roof, the edges can be beveled if desired but not necessarily required.

Also the panels can be used to construct a door. The simplest way to do this is to have a panel with a non-vacuum section where the doorknob could be installed.

The paneling systems are just that, a system. They can be used to make part of a structure that is not specifically a greenhouse. They can also be used to construct certain walls and ceilings in a room of a regular house. The panels can be installed on any structural frame, including wood-framed greenhouses. For instance, the paneling system can be used for a roof to turn an attic into a greenroom and to preserve the energy which normally escapes through the roof of a home. Insulation is currently used in attics to prevent heat from transferring out of the house. In sections of a roof that employ the paneling system, this insulation would not be necessary.

1. Separate multiple clear vacuum panels which includes being interconnected by various means to create a single or multiple larger vacuum chambers which can be used as walls and or ceiling of a structure.

2. The panels of claim 1 wherein said panels comprising of two sheets of transparent material being supported by a plurality of single or connected support columns of any shape at places in the interior to prevent collapse of said sheets.

3. The panels of claim 1 wherein said panels includes being connected together by welding.

4. The panels of claim 1 wherein said panels include being connected together by hoses or other various means.

5. The panels of claim 1 wherein said panels comprising of nozzles thereby allowing said panels to connect to other panels.

6. The nozzles of claim 5 wherein said nozzles of panels include not connected to other panels being capped or closed off.

7. Everything in claim 1 includes the purpose of growing food.

8. Everything in claim 1 includes being used for a roof of a home.

9. A wall or ceiling vacuum chamber comprising of being maintained or changed by an active vacuum pump or pumps.

10. The chamber of claim 9 wherein said pump or pumps include actively changing the pressure inside the chamber based upon environmental conditions.

11. The panels of claim 9 wherein said pump includes compensating for loss of vacuum over time in the chamber.

12. The vacuum chamber of claim 9 wherein said chamber includes being actively controlled by a micro-controller or other electronic device.

13. Everything in claim 9 includes the purpose of growing food.

14. Everything in claim 9 includes being used for a roof of a home.

15. Vacuum panel comprising of an overhanging edge that can be used to attach to a structural member and become part of a wall or ceiling.

16. The over hanging edges of claim 15 wherein said edges includes being patterned to have gaps that allow the panel next to it to attach to the frame or support member.

17. The over hanging edges of claim 15 wherein said edges includes being less than or equal to half the width of the support member between two panels.

18. Everything in claim 15 includes the purpose of growing food.

19. Everything in claim 15 includes being used for a roof of a home.
